(19) United States
(12) Patent Application Publication
(10) Pub. No.: US 2025/0244634 A1
(43) Pub. Date: Jul. 31, 2025

(54) METASURFACE DEVICES AND MANUFACTURING USING SEQUENTIAL SINGLE-DAMASCENE PROCESSES WITH PROTECTIVE DIELECTRIC CAP LAYERS

(71) Applicant: Lumotive, Inc., Redmond, WA (US)

(72) Inventors: Erik Edward Josberger, Renton, WA (US); Lie "Larry" Zhao, Washougal, WA (US); Linda Gail Conway, Duvall, WA (US); Gleb M. Akselrod, Kenmore, WA (US)

(21) Appl. No.: 18/423,218

(22) Filed: Jan. 25, 2024

(51) Int. Cl. G02F 1/29

(52) U.S. Cl. CPC G02F 1/29

(57) ABSTRACT

This disclosure relates to optical metasurfaces and methods of manufacturing optical metasurfaces. An optical metasurface may, for example, include an optical reflector layer with metallic reflector patches, a resonator layer with an array of vertically extending metallic elements spaced to form optical resonators, and an interconnect layer positioned between the reflector layer and the resonator layer. The interconnect layer includes metallic vias that electrically connect the metallic resonator elements of the resonator layer with the reflector patches of the reflector layer. A first single-damascene process is used to form the metallic vias with an upper dielectric cap layer. A second single-damascene process is used to form the metallic elements of the resonator layer.

### TECHNICAL FIELD

This disclosure relates to optical metasurfaces, including tunable optical metasurfaces. More specifically, this disclosure relates to damascene processes for metallic deposition in semiconductor devices.

### BRIEF DESCRIPTION OF THE DRAWINGS

FIG. 1A shows a top overview of a metallic holographic metasurface device in accordance with the embodiments of the disclosure.

FIG. 1B is a cross-sectional view of a one-dimensional metallic holographic metasurface device in accordance with embodiments of the disclosure.

FIG. 2A shows a cross-sectional view of one subwavelength holographic element, including a pair of copper pillars and a full backplane structure in the array of FIG. 1B, in accordance with embodiments of the disclosure.

FIG. 2B shows a cross-sectional view of one subwavelength holographic element, including a pair of copper pillars and a partial backplane structure, in accordance with the embodiments of the disclosure.

FIG. 3 illustrates an example of a one-dimensionally steerable metasurface, according to one embodiment.

FIG. 4 illustrates a perspective view of a simplified block diagram of reflective and resonator layers of a two-dimensional optical metasurface, according to one embodiment.

FIG. 5 illustrates a side-view diagram of the layers of a portion of a tunable optical metasurface, according to one embodiment.

FIG. 6A illustrates an example diagram of a top view of an XY plane of a tunable optical metasurface, according to one embodiment.

FIG. 6B illustrates an example diagram of a first cut-away side view of an XZ plane of the tunable optical metasurface of FIG. 6A, according to one embodiment.

FIG. 6C illustrates an example diagram of a second cut-away side view of the XZ plane of the tunable optical metasurface of FIG. 6A, according to one embodiment.

FIGS. 7A-7H illustrate block diagrams of a first single-damascene process to form a via structure with an interconnect layer that includes an etch-resistant dielectric cap layer, according to one embodiment.

FIGS. 8A-8J illustrate block diagrams of a second single-damascene process to form optical resonators with metallic optical elements with a resonator etch-stop layer, according to one embodiment.

FIGS. 9A-9G illustrate block diagrams of an alternative second single-damascene process to form a metal structure without a resonator etch-stop layer, according to one embodiment.

FIGS. 10A and 10B illustrate block diagrams of exemplary etching defects created during a second single-damascene process in the absence of a protective dielectric cap layer, according to one embodiment.

### DETAILED DESCRIPTION

According to various embodiments, a metasurface includes a one-dimensional or two-dimensional array of optical resonators. The metasurface may include an optical reflector layer to reflect electromagnetic radiation within an operational bandwidth, a resonator layer with optical resonators extending vertically therein, and an interconnect layer with metallic vias to selectively connect metallic optical elements of the optical resonators to reflector patches of the reflector layer. In various embodiments, the optical reflector layer includes a plurality of metallic reflector patches. In various embodiments, each optical resonator of the resonator layer is formed by two vertically extending metallic optical elements positioned adjacent to one another to form a gap between them. In various embodiments, the interconnect layer is positioned between the optical reflector layer and the resonator layer and includes a plurality of metallic vias. Each metallic via may, for example, electrically connect one of the metallic optical elements of the resonator layer with one of the metallic reflector patches of the optical reflector layer.

In some embodiments, a first conductive barrier is deposited during a first single-damascene process used to form the metallic vias of the interconnect layer. The first conductive barrier physically separates the metallic vias from the metallic reflector patches. However, since the first conductive barrier is electrically conductive, the first conductive barrier layer also electrically connects the metallic vias to the metallic reflector patches. The second conductive barrier is deposited during a second single-damascene process used to form the metallic optical elements of the resonator layer. The second conductive barrier electrically connects but physically separates the metallic vias and the metallic optical elements.

The use of sequential single-damascene processes results in a conductive barrier that physically separates the metallic optical elements of the optical resonators from the underlying metallic vias. In contrast, a dual-damascene process would result in the formation of each metallic optical element and underlying metallic via as an integrated single unit. The dual-damascene process does not work well when the aspect ratio of the underlying metallic via is relatively high as compared to the aspect ratio of the connected metallic optical element. For example, a relatively thin or narrow metallic via is difficult to form beneath a relatively wide metallic optical element using a dual-damascene process.

However, the use of traditional single-damascene processes can result in defects, rounded corners, over-etching of surrounding and supporting dielectrics, and other problems. One solution that is commonly employed is to route connections to the etches or to other “dead” spaces where the vias can be enlarged relative to the metallic optical elements, thereby allowing for the use of the dual-damascene process.

The presently described systems and methods include the use of sequential single-damascene processes with a protective dielectric cap layer formed as part of the interconnect layer. Each metallic via, metallic optical element, and/or metallic reflector patch may be copper or be a copper alloy, such that the damascene processes are copper damascene processes. However, adaptations of damascene processes may be utilized for other metals and metal alloys, such as those including silver, gold, aluminum, copper, etc.

The damascene processes may include the deposition of a conductive barrier layer, such as one or more of tantalum (Ta), tantalum nitride (TaN), and titanium nitride (TIN). The bulk metal (e.g., copper) may then be deposited as a seed layer followed by a fill layer, as understood by those of skill in the art. According to various embodiments, the resonator array includes a one-dimensional or two-dimensional array of optical resonators, each of which comprises two vertically extending metallic optical elements that are spaced apart to form a gap between them. The gap may, for example, be filled with a tunable dielectric material such that the optical resonators are tunable optical resonators. The tunable dielectric material may be, for example, one or more of: liquid crystal, an electro-optic polymer, electro-optical crystal, and chalcogenide glass.

The two-vertically extending metallic optical elements may be rails (to form a one-dimensional array) or pillars (to form a two-dimensional array) that have any of a wide variety of shapes (e.g., cylinders, rectangular prisms, n-sided polygonal prisms, etc.).

In some examples, the interconnect layer in which the metallic vias are formed includes a dielectric etch-stop layer to control an etch depth in the interconnect layer, a dielectric mid-layer to be etched as part of a first single-damascene process, and a dielectric cap layer resistant to being etched by an etching solution used to etch the resonator layer during the second single-damascene process. In many of the embodiments described herein, each metallic via electrically connects one of the metallic optical elements of the resonator layer with one of the metallic reflector patches of the optical reflector layer. Ultimately, the metallic reflector patches are driven by transistors, capacitors, control lines, and/or other driver components, such that the metallic vias serve to convey drive voltages to the metallic optical elements.

In some examples, the dielectric etch-stop layer of the interconnect layer includes one or more of a silicon nitride layer, a silicon carbide layer, and a silicon carbonitride layer. The dielectric mid-layer of the interconnect layer may be, for example, tetraethyl orthosilicate (TEOS). The dielectric cap layer may be a silicon carbide layer, alumina (Al₂O₃), and/or a silicon nitride layer. In one example, the dielectric cap layer includes a nitrogen-doped silicon carbide (NDC) layer, such as a layer of NBLOK® from Applied Sciences, Inc. In another implementation, the dielectric cap layer includes a layer of silicon carbide deposited using plasma-enhanced chemical vapor deposition (PECVD) of trimethylsilane, such as a layer of BLOK® from Applied Sciences, Inc.

Methods to manufacture the various embodiments and variations of metasurfaces described herein include forming an optical reflector layer that includes a plurality of metallic reflector patches, forming an interconnect layer above the optical reflector layer by a first single-damascene process, and forming a resonator layer by a second single-damascene process. The interconnect layer is formed to include a plurality of metallic vias within an interconnect dielectric etch-stop layer, an interconnect dielectric mid-layer, and an etch-resistant dielectric cap layer. The second single-damascene process is used to form the resonator layer with an array of tunable optical resonators with tunable dielectric material positioned within the gap between the adjacent metallic optical elements of each respective optical resonator.

This disclosure may be understood by reference to the following detailed description, taken in conjunction with the drawings as described below. It is noted that, for purposes of illustrative clarity, certain elements in various drawings may not be drawn to scale, and other elements may be omitted to avoid obscuring the focus of this application.

Additional descriptions, variations, functionalities, and usages for optical metasurfaces are described in U.S. Pat. No. 10,451,800 granted on Oct. 22, 2019, entitled “Plasmonic Surface-Scattering Elements and Metasurfaces for Optical Beam Steering;” U.S. Pat. No. 10,665,953 granted on May 26, 2020, entitled “Tunable Liquid Crystal Metasurfaces;” and U.S. Pat. No. 11,092,675 granted on Aug. 17, 2021, entitled “Lidar Systems based on Tunable Optical Metasurfaces,” each of which is hereby incorporated by reference in its entirety. Many of the metasurfaces described in the above-identified U.S. patents include one-dimensional arrays of parallel rails, two-dimensional arrays of elongated rails, and/or two-dimensional arrays of pillars positioned above a planar reflective surface, reflective layers, or optically transmissive surfaces.

This disclosure includes various embodiments and variations of tunable optical metasurface devices and methods for manufacturing the same. It is appreciated that the metasurface technologies described herein may incorporate or otherwise leverage prior advancements in surface scattering antennas, such as those described in U.S. Patent Publication No. 2012/0194399, published on Aug. 2, 2012, entitled “Surface Scattering Antennas;” U.S. Patent Publication No. 2019/0285798 published on Sep. 19, 2019, entitled “Plasmonic Surface-Scattering Elements and Metasurfaces for Optical Beam Steering;” and U.S. Patent Publication No. 2018/0241131 published on Aug. 23, 2018, entitled “Optical Surface-Scattering Elements and Metasurfaces;” each of which is hereby incorporated by reference in its entirety. Additional elements, applications, and features of surface scattering antennas are described in U.S. Patent Publication No. 2014/0266946, published Sep. 18, 2014, entitled “Surface Scattering Antenna Improvements;” U.S. Patent Publication No. 2015/0318618, published Nov. 5, 2015, entitled “Surface Scattering Antennas with Lumped Elements;” U.S. Patent Publication No. 2015/0318620 published Nov. 5, 2015, entitled “Curved Surface Scattering Antennas;” U.S. Patent Publication No. 2015/0380828 published on Dec. 31, 2015, entitled “Slotted Surface Scattering Antennas;” U.S. Patent Publication No. 2015/0162658 published Jun. 11, 2015, entitled “Surface Scattering Reflector Antenna;” U.S. Patent Publication No. 2015/0372389 published Dec. 24, 2015, entitled “Modulation Patterns for Surface Scattering Antennas;” PCT Application No. PCT/US18/19269 filed on Feb. 22, 2018, entitled “Control Circuitry and Fabrication Techniques for Optical Metasurfaces,” U.S. Patent Publication No. 2019/0301025 published on Oct. 3, 2019, entitled “Fabrication of Metallic Optical Metasurfaces;” U.S. Publication No. 2018/0248267 published on Aug. 30, 2018, entitled “Optical Beam-Steering Devices and Methods Utilizing Surface Scattering Metasurfaces;” and U.S. patent application Ser. No. 17/685,621 filed on Mar. 3, 2022, entitled “Liquid Crystal Metasurfaces with Cross-Backplane Optical Reflectors,” each of which is hereby incorporated by reference in its entirety.

In various embodiments, the elongated metal rails, pillars, or other metallic extension structures (e.g., metallic optical elements) have subwavelength dimensions suitable for operation within a specific bandwidth of optical frequencies (e.g., a bandwidth of infrared optical frequencies). The width of each metallic optical element may be, for example, less than the smallest wavelength of the operational bandwidth.

Tunable optical metasurfaces may be used for beamforming, including three-dimensional beam shaping, two-dimensional beam steering, and/or one-dimensional beam steering. The presently described systems and methods can be applied to tunable metasurfaces utilizing various architectures and designs to deflect optical radiation within an operational bandwidth. In various embodiments, a controller or metasurface driver selectively applies a pattern of voltages to an array of optical structures. Voltage differentials across adjacent optical structures modify the refractive indices of dielectric material therebetween. A combination of phase delays created by the pattern of applied voltages creates constructive interference in the desired beam steering direction. The voltages are, for example, conveyed by the metallic vias to the metallic optical elements forming the tunable optical resonators. In some embodiments, the metallic vias connect the metallic optical elements to reflector patches of the reflector layer. In such embodiments, the reflector patches are then connected to the control lines of a driver, capacitors, transistors, and/or other driver components to selectively drive voltage differentials across the various tunable optical resonators.

Various examples of tunable optical metasurfaces are described herein and depicted in the figures. For example, a tunable optical metasurface includes an array of metal extension elements (e.g., antenna elements, resonator elements, elongated resonator rails, arrays of metal pillars, pairs of resonator pillars, etc. that extend from a dielectric substrate above a metallic reflector). For instance, in some embodiments, the array of metal elements comprises a one-dimensional array of elongated metal resonator rails arranged parallel to one another with respect to an optical reflector, such as an optically reflective layer of metal or a Bragg reflector. Liquid crystal, or another refractive index tunable dielectric material, is positioned in the gaps or channels between adjacent resonator rails (e.g., adjacent elongated metal rails). Liquid crystal is used in many of the examples provided in this disclosure. However, it is appreciated that alternative dielectric materials with tunable refractive indices and/or combinations of different dielectric materials with tunable refractive indices may be utilized instead of liquid crystal in many instances. Examples of suitable tunable dielectric materials that have tunable refractive indices include liquid crystals, electro-optic polymer, chalcogenide glasses, and/or various semiconductor materials.

In various embodiments, biasing the liquid crystal in a metasurface with a pattern of voltage biases changes the reflection phase of the optical radiation. For example, each different voltage pattern applied across the metasurface corresponds to a different reflection phase pattern. Each different reflection phase pattern of a one-dimensional array of optical structures (e.g., elongated metal resonator rails) corresponds to a different steering angle in a single dimension. A digital or analog controller (controlling current and/or voltage), such as a metasurface driver, may apply a differential voltage bias pattern to achieve a target beam shaping, such as a target beam steering angle. The term “beam shaping” is used herein in a broad sense to encompass one-dimensional beam steering, two-dimensional beam steering, wavelength filtering, beam divergence, beam convergence, beam focusing, and/or controlled deflection, refraction, and/or reflection of incident optical radiation.

Various examples and metal elements, such as elongated metal rails and metal pillars, are illustrated and described in many instances as being copper or as including copper (e.g., a copper alloy). Copper antenna elements may, for example, be fabricated using sequential single-damascene processes for semiconductor devices. However, it is appreciated that other metals may also be utilized, including but not limited to tungsten, aluminum, copper alloys, and/or combinations thereof.

Any of the variously described embodiments herein may be manufactured with dimensions suitable for optical bandwidths for optical sensing systems such as LiDAR, optical communications systems, optical computing systems, and displays. For example, the systems and methods described herein can be configured with metasurfaces that operate in the sub-infrared, mid-infrared, high-infrared, and/or visible-frequency ranges (generally referred to herein as “optical”). Given the feature sizes needed for sub-wavelength optical antennas and antenna spacings, the described metasurfaces may be manufactured using micro-lithographic and/or nano-lithographic processes, such as fabrication methods commonly used to manufacture complementary metal-oxide-semiconductor (CMOS) integrated circuits.

The components of some of the disclosed embodiments are described and illustrated in the figures herein to provide specific examples. Many portions thereof could be arranged and designed in a wide variety of different configurations. Furthermore, the features, structures, and operations associated with one embodiment may be applied to or combined with the features, structures, or operations described in conjunction with another embodiment. In many instances, well-known structures, materials, or operations are not shown or described in detail to avoid obscuring aspects of this disclosure. The right to add any described embodiment or feature to any one of the figures and/or as a new figure is explicitly reserved.

The embodiments of the systems and methods provided within this disclosure are not intended to limit the scope of the disclosure but are merely representative of possible embodiments. In addition, the steps of a method do not necessarily need to be executed in any specific order, or even sequentially, nor do the steps need to be executed only once, except as explicitly stated or as contextually understood by one of skill in the art.

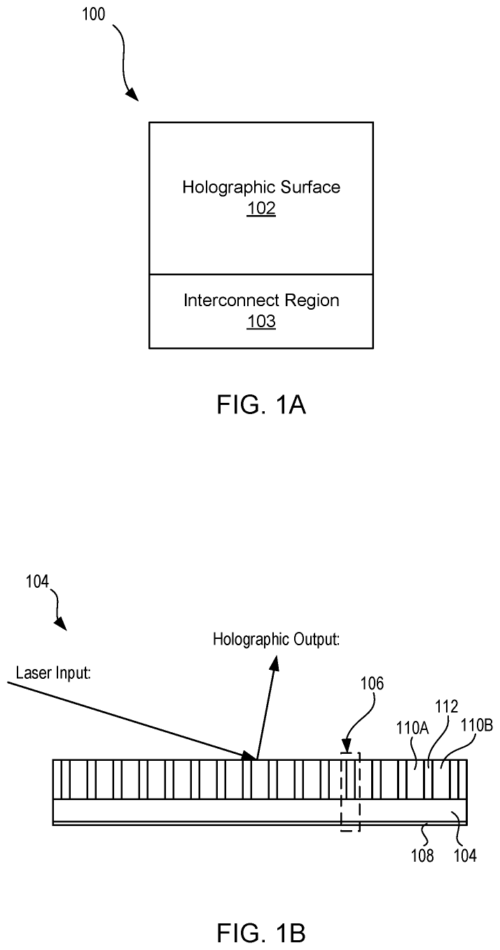

FIG. 1A shows a top overview of a metallic holo-graphic metasurface device in accordance with embodiments of the disclosure. A metallic holographic metasurface device 100 has a metallic holographic metasurface region 102, including an array of holographic elements on a first portion of a base 108, which can be seen in FIG. 1B. The metallic holographic metasurface region 102 includes an array of hologram elements. Each holographic element includes a pair or pairs of metal pillars and a refractive index tunable core material (e.g., a dielectric material with an electrically tunable refractive index) between the pair of metal pillars.

The holographic metasurface device 100 may also have an interconnect region 103 with CMOS transistors on a second portion of the chip. The CMOS transistors in the interconnect region 103 can control the voltage applied to the metal pillars of each of the holographic elements. The CMOS transistors have low static power consumption and high noise immunity. The array of holographic elements and the electrical control circuit are decoupled. In some embodiments, the interconnect region 103 may include a complex routing of wires with no active elements.

In some embodiments, the interconnect region may be at least partially mixed within the holographic metasurface (not shown). For instance, the metallic holographic metasurface may have an active control in which the circuits are partially below the holographic surface.

FIG. 1B is a cross-sectional view of a one-dimensional metallic holographic metasurface device in accordance with embodiments of the disclosure. As shown in FIG. 1B, metallic holographic metasurface includes a plurality of columns or an array of metallic holographic elements 106 arranged linearly on a wafer. Each metallic holographic element 106 (e.g., metallic resonators or metallic antenna elements) includes a pair of metal pillars 110A and 110B and an electrically tunable material 112 between the metal pillars. The metal pillars are deposited over a reflective backplane structure 104. In some embodiments, the backplane structure 104 may include one of a full backplane, a partial backplane, a notch design, a Bragg reflector, or another reflector layer as described in the patent applications incorporated herein by reference.

The grazing incidence of the incident wave, such as a laser input, excites resonances in the gaps between the metal pillars with a relatively high Q factor, enabling dynamic modulation of the phase. Additionally, the metal pillars are deposited over a backplane structure, which makes the structure operate as a reflectarray and thus is possible to integrate with control electronics. The resonator includes two metal pillars that are separated by an electrically tunable material having a tunable refractive index. The resonator produces a holographic output, as shown in FIG. 1B.

The reflection phase of the metal pillars is sensitive to the refractive index of the core material, with phase modulation of nearly 2π possible with an index modulation of Δn/n of about 7%. The high sensitivity to the refractive index of the core material is enabled by the high Q of the resonance, for example, a Q of 20. The high sensitivity of the reflection phase to the refractive index of the core enables the integration of refractive index tunable core material into the gaps between the metal elements to create dynamic metasurfaces.

Since the refractive index modulation range of the tunable dielectric materials may be small, one challenge for designing an array of tunable radiating or scattering elements is to create a high Q factor, low-loss, subwavelength resonators. The Q factor is a dimensionless parameter that characterizes a resonator's bandwidth relative to its center frequency. A high Q factor indicates a lower rate of energy loss relative to the stored energy of the resonator. Resonators with high Q factors have low damping.

The backplane structure 104 is deposited over a base 108 to support the metal pillars or rails. In some embodiments, the base 108 may include a wafer substrate, which may be a crystalline silicon wafer, among others. In some embodiments, the base 108 may include a wafer substrate and/or also a plurality of layers for wires, capacitors, control devices, transistors, driver elements, etc.

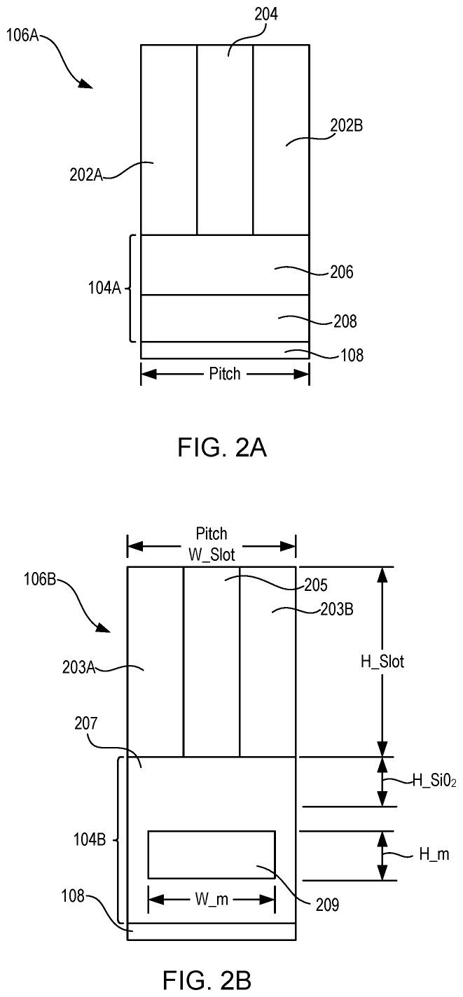

FIG. 2A shows a cross-sectional view of one of the sub-wavelength holographic element 106A having a resonator including a pair of metal pillars 202 (202A and 202B) and a full backplane structure in the array of FIG. 1B in accordance with embodiments of the disclosure. The backplane structure 104 reflects optical waves. A control voltage is applied across the metal pillars 202 to create a static electric field across the holographic element 106A. Both the electric field and magnetic field are well confined to the electrically tunable material 204 in the nano-gap between the two metal pillars 202A and 202B.

As depicted, a metallic holographic element 106A, e.g., a sub-wavelength metallic holographic element, includes a resonator having an electrically-tunable material or refractive index tunable material 204 between two metal pillars 202, over a backplane structure 104A, which is placed between the base 108 and metal pillars 202A-B. The full backplane structure 104A may include a dielectric spacer layer 206 over a metal layer 208, as shown in FIG. 2A. The dielectric spacer layer 206 may include at least one thin chemically resistant layer and a relatively thick dielectric layer.

Both the electric field and magnetic field are well confined to the electrically tunable material 204 in the nano-gap between the two metal pillars 202A-202B. The electric field and magnetic field are mostly confined between both the top end and the bottom end of the resonator.

FIG. 2B shows a cross-sectional view of one of the subwavelength holographic element 106B having a resonator including a pair of metal pillars 203A and 203B and a partial backplane structure in the array of FIG. 1B in accordance with embodiments of the disclosure. As depicted, a metallic holographic element 106B, e.g., a sub-wavelength metallic holographic element, includes a resonator having a refractive index tunable material 205 between two metal pillars 203A and 203B, over a backplane structure 104B, which is placed between the base 108 and metal pillars 203A-B. The partial backplane structure 104B may include a metal patch 209 embedded in a dielectric layer 207. The metal patch 209 may be in a rectangular shape with a height labeled H_m and a width labeled W_m. The metal patch 209 is located under the electrically tunable material 205. The width of the metal patch 209 may vary from zero to nearly the pitch. When the width of the metal patch equals the pitch, the partial backplane structure becomes a full backplane structure.

When the metal patch is formed of copper, the width of the copper patch may be designed by considering the impact of the width on both manufacturing and optical performance. It may be easier to fabricate the copper patch with a reduced width. However, the optical performance may improve as the width of the copper patch increases (e.g., higher reflectivity). Again, both the electric field and magnetic field are well confined to the electrically tunable material 205 in the nano-gap between the two metal pillars 203A-B. Both the electric field and magnetic field are mostly confined between both the top end and the bottom end of the resonator.

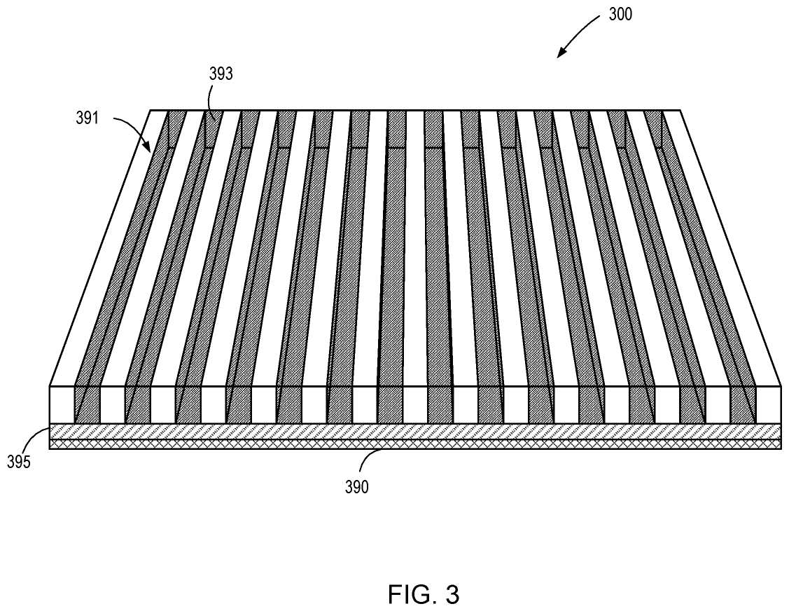

FIG. 3 illustrates an example of a one-dimensionally steerable metasurface 300, according to various embodiments. The tunable metasurface 300 can, for example, be used as part of a solid-state optical transmitter subsystem, receiver subsystem, or transceiver system of a software-defined lidar device. As illustrated, the tunable metasurface 300 includes an optically reflective substrate 390 and a dielectric layer 395. A plurality of elongated rails 391 may be arranged at sub-wavelength intervals on the optically reflective substrate 390. Liquid crystal or another refractive index tunable dielectric material 393 may be positioned between the elongated rails 391, as described in the context of the various one-dimensionally steerable metasurfaces described in the references incorporated herein by reference. The metasurface 300 can be used for one-dimensional beam steering of optical radiation at various steering angles (e.g., scan lines steering along a single axis).

FIG. 4 illustrates a perspective view of a simplified block diagram of a reflective layer 410 and resonator layer 420 of a two-dimensional optical metasurface 400, according to one embodiment. As illustrated, the resonator layer 420 includes a two-dimensional array of metallic optical pillars 425 arranged in parallel rows. Each pillar 425 in the resonator layer 420 extends vertically relative to an underlying substrate layer (not shown). The pillars 425 in each row may be spaced from one another by less than a smallest wavelength in an operational bandwidth. The width (W) of each pillar 425 along each row may be less than one-half of the smallest wavelength of the operational bandwidth. The length (L) of each pillar 425 in a direction perpendicular to each row (e.g., along the columns) may be less than the smallest wavelength of the operational bandwidth.

The gaps between adjacent pillars 425 in each row of pillars form optical resonators. A tunable dielectric material may be deposited within the resonator layer to fill the spaces between the pillars 425 in all directions, such that tunable dielectric material is positioned within the optical resonators formed by the gaps between row-adjacent pillars 425. Examples of suitable tunable dielectric materials that have tunable refractive indices include liquid crystals, electro-optic polymer, electro-optical crystals, chalcogenide glasses, and/or various semiconductor materials.

In alternative embodiments, the pillars 425 in each row may be spaced from one another by more than a wavelength in an operational bandwidth (e.g., ten times the largest wavelength in the operational bandwidth). Similarly, in some embodiments, the width (W) of each pillar 425 along each row may be more than one-half of the smallest wavelength, and the length (L) of each pillar 425 in a direction perpendicular to each row (e.g., along the columns) may be many times larger than the largest wavelength of the operational bandwidth.

The reflective layer 410 includes a two-dimensional array of elongated rectangular reflector patches 415 extending lengthwise along parallel rows. That is, as illustrated, the reflector patches 415 extend lengthwise in a direction that is perpendicular with respect to the lengthwise direction of the pillars 425. An electrical isolation gap 430 separates reflector patches 415 in adjacent rows. An off-resonance gap 440 separates adjacent reflector patches 415 in the same row. The direction of the electrical isolation gap 430 is off-resonance with the incident electric field so there is no resonant coupling. The off-resonance gap 440 between adjacent reflector patches 415 is perpendicular to the incident electrical field. Accordingly, the dimension of the off-resonance gap 440 is selected to minimize or avoid any possible resonance between reflector patches 415 in the same row, for a range of optical radiation wavelengths. The off-resonance gap 440 may be a different size than the electrical isolation gap 430.

A dielectric via layer 450 may be positioned between the reflective layer 410 and the resonator layer 420. Each pillar 425 may be electrically connected to one underlying reflector patch 415 by a conductor via 455 within the dielectric via layer 450. The dielectric of the dielectric via layer 450 has been removed from the figure for clarity to show the positioning of the conductor vias 455. Additional examples and details related to two-dimensional tunable optical metasurfaces are described in U.S. Pat. No. 11,856,865 titled “Two-dimensional Metasurface Beam Forming Systems and Methods,” granted on Dec. 19, 2023, which application is incorporated herein by reference in its entirety.

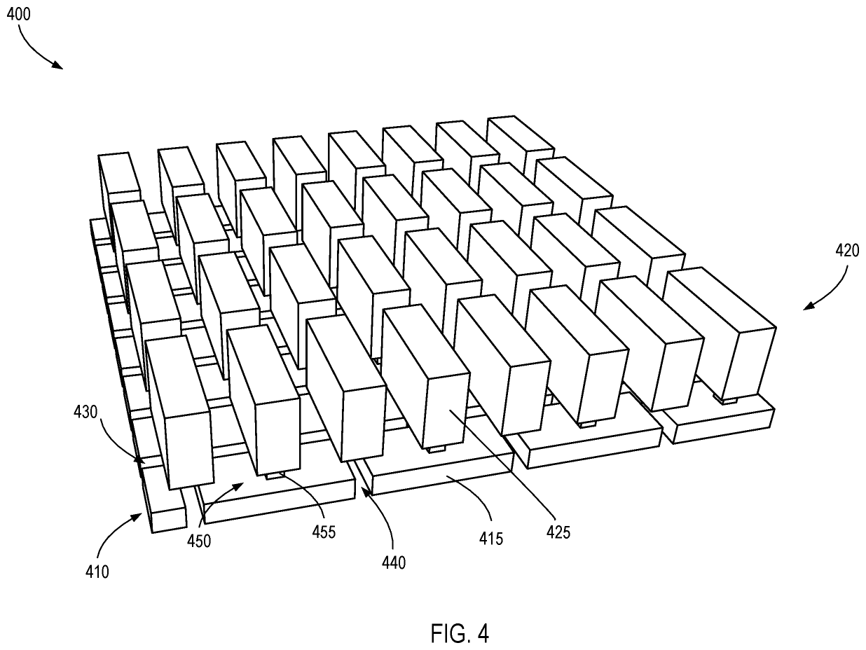

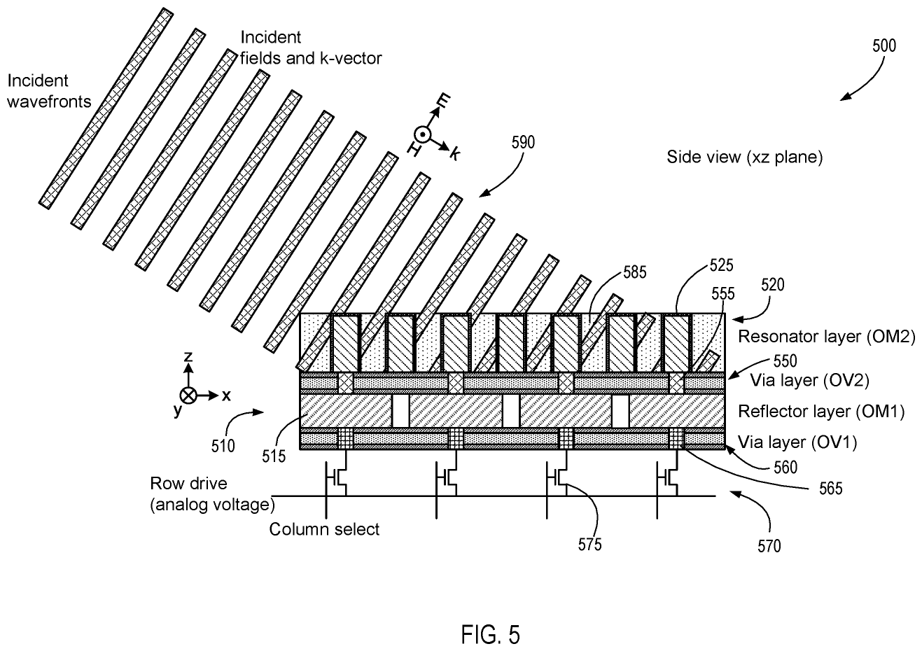

FIG. 5 illustrates a side-view diagram of the layers of a portion of a tunable optical metasurface 500 with active-matrix addressing, according to one embodiment. In the illustrated cross-sectional view, a single row of optical resonators is formed by the metallic optical pillars 525 in the resonator layer 520. The pillars 525 extend vertically relative to a substrate layer (not shown) and lengthwise into the page. A dielectric via layer 550 includes conductor vias 555 that connect the pillars 525 to reflector patches 515 within a reflective layer 510. As illustrated, the reflector patches 515 are staggered or offset with respect to one another such that the reflector patches 515 for every other pillar 525 are not visible in the cross-sectional view. The illustrated example includes a second via layer 560 with conductor vias 565 to connect the pillars 525 to the control lines and transistors 575 within the control layer 570.

The active matrix architecture enables the resonant unit cells of the metasurface 500 to exhibit a unique pattern of phase responses (ϕ) as a function of the row drive (x) and the column select (y), expressible as ϕ=f(x,y). The incident fields and k-vector of the wavefront of the optical radiation 590 are depicted. The metasurface 500 may be used for arbitrary phase modulation of the incident optical radiation 590 for beam steering, lensing, or another optical functionality.

As illustrated, the active matrix addressing scheme includes a transistor 575 beneath each resonant unit cell. In some embodiments, each resonant unit cell includes only a single transistor connected to one of the pillars, with the other pillar connected to a fixed voltage. In other embodiments, each resonant unit cell includes two transistors, with one transistor connected to each metallic optical pillar such that each metallic optical pillar can be driven with a unique voltage. While an absolute voltage is applied to each metallic optical pillar, the phase of each resonant unit cell depends on the voltage difference between adjacent metallic optical pillars.

According to various embodiments, the dielectric via layer 550 also functions as a waveguide layer in between the resonator layer 520 and the reflector layer 510. The thickness of the waveguide layer is such that destructive interference of the fields is created at the bottom of the optical resonator (e.g., the gap between row-adjacent optical metallic pillars), thus confining most of the optical energy to the vertical pillars with minimal leaking into the waveguide layer.

The resonant unit cells are tuned via the refractive-index tunable material 585 between adjacent metallic optical pillars 525. For example, liquid crystal, which has a high refractive index tuning range, may be used. As described herein, a differential voltage is applied between adjacent metallic optical pillars 525, which rotates the liquid crystals in that resonant unit cell, changing the refractive index experienced by the x component of the optical electric field. This consequently changes the effective length of the metallic optical pillars 525, and hence the phase experienced by the incident optical radiation 590 at that location on the metasurface. Since the resonant unit cells are resonant, changes in the phase are coupled to changes in the amplitude response in many embodiments, as is typical of Lorentz-type resonators. In such embodiments, each metallic optical pillar 525 is programmed with a unique voltage (hence phase) such that a desired spatial phase gradient is achieved. This gradient can be used for beam steering or other optical functionality such as focusing, collimating, or any arbitrary optical transformation.

Again, the metallic optical pillars 525 can be implemented in conventional CMOS manufacturing processes, such as those based on copper damascene metallization, deposition processes, etching processes, lithography processes, patterning processes, chemical mechanical planarization processes, and the like. Other metals besides copper, such as aluminum, silver, and gold, can also be used to form the metal core of each metallic optical pillar. Copper is attractive because it is widely used in the semiconductor industry to make transistors interconnects with the dimensions required to implement these resonant unit cells. In addition, copper has excellent optical properties across near-IR and short-wave IR wavelengths.

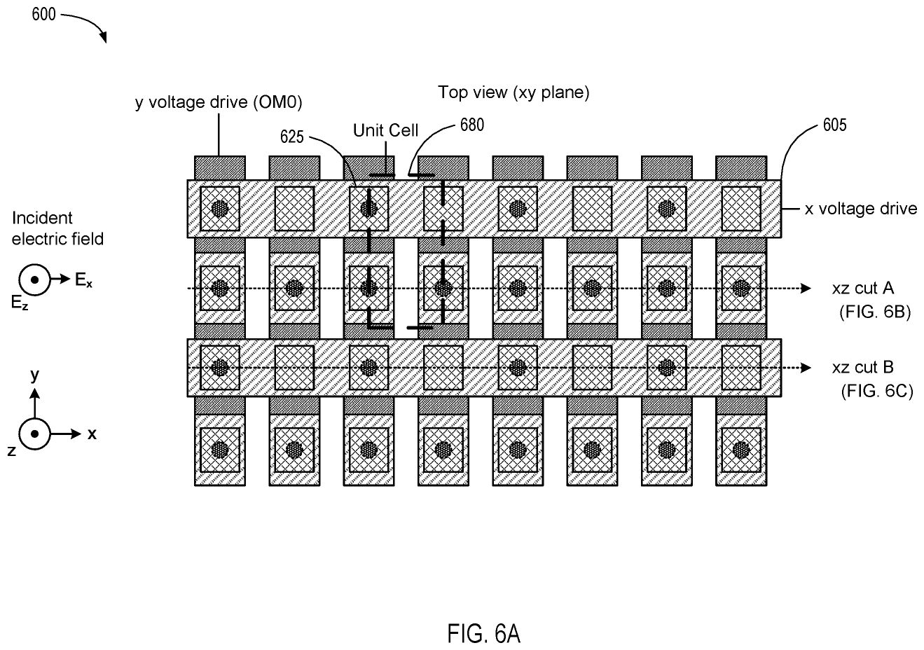

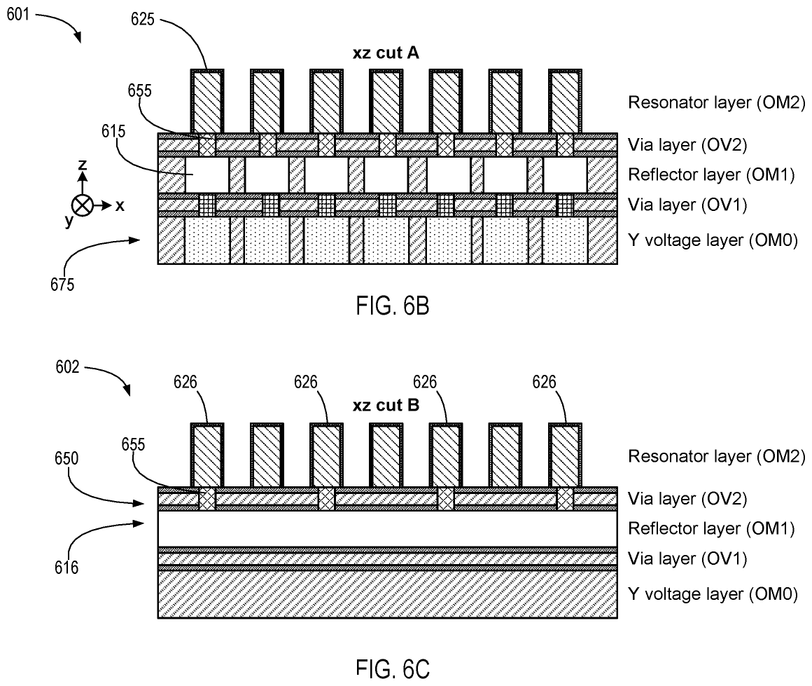

FIG. 6A illustrates an example diagram of a top view of the XY plane of a tunable optical metasurface 600, according to one embodiment. In the illustrated example, the unit cell 680 includes four metallic optical pillars, including one metallic optical pillar 625 that is connected to a continuous control line 605 that provides a drive voltage (x voltage). All the metallic optical pillars connected to the continuous control line 605 (illustrated with the connection dots) are driven to the same voltage via the continuous control line 605.

FIG. 6B illustrates an example diagram of a first cross-sectional side view 601 of the XZ plane of the tunable optical metasurface 600 of FIG. 6A at the indicated “cut A” location, according to one embodiment. As illustrated, each metallic optical pillar 625 is connected to an underlying reflector patch 615 by a conductor via 655 and to a control line and/or transistor in the “Y voltage layer” 675.

FIG. 6C illustrates an example diagram of a second cross-sectional side view 602 of the XZ plane of the tunable optical metasurface of FIG. 6A at the indicated “cut B” location, according to one embodiment. As illustrated, every other (alternating) metallic optical pillar 626 is connected to a continuous reflector patch 616 by conductor vias 655 in the dielectric via layer 650.

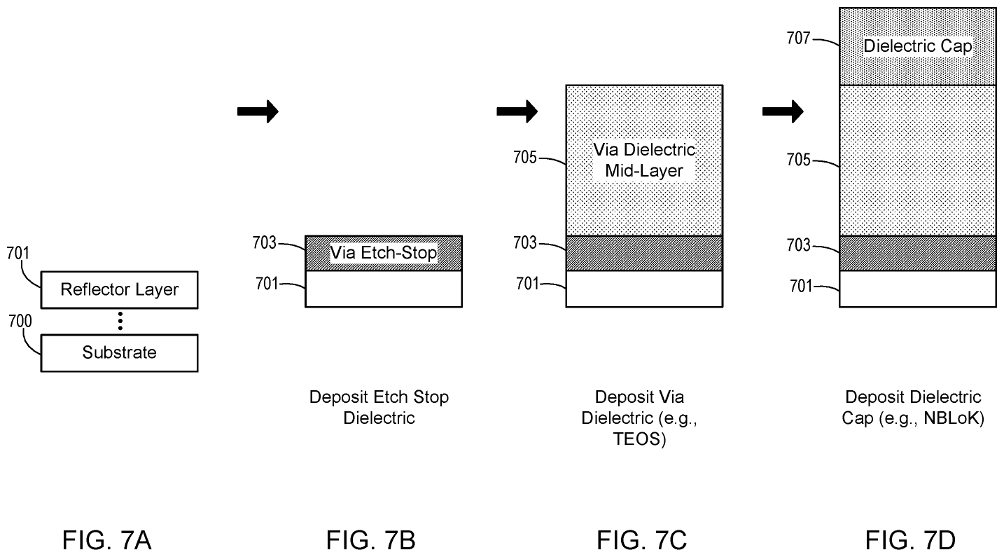

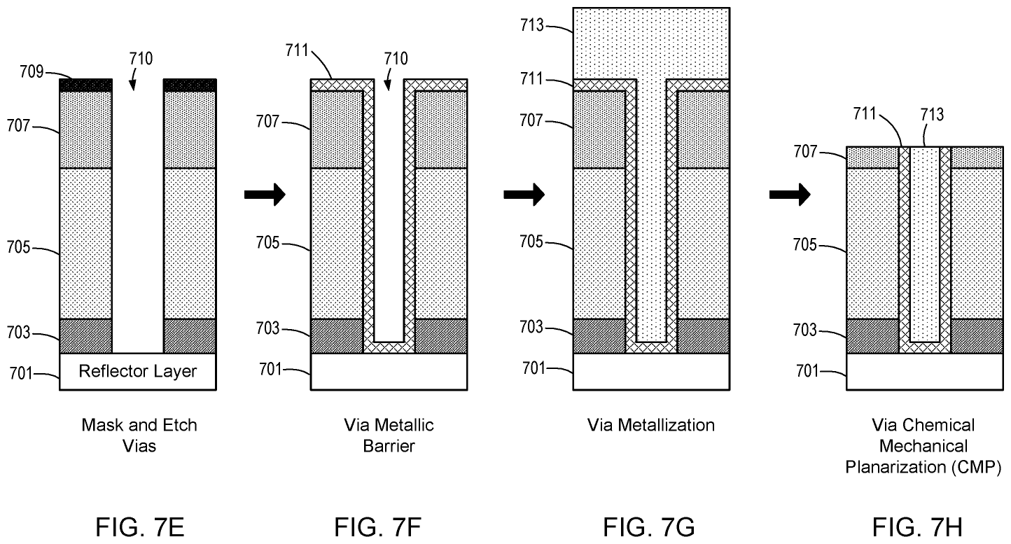

FIGS. 7A-7H illustrate block diagrams of a first single-damascene process to form a via structure with an interconnect layer that includes an etch-resistant dielectric cap layer, according to one embodiment.

FIG. 7A illustrates a reflector layer 701 positioned above a substrate 700, according to one embodiment. Any number of other layers may be positioned between the substrate 700 and the reflector layer 701. The reflector layer 701 may be embodied as the reflector layer of reflector patches 615 (OM1) and described in conjunction with FIGS. 6A-6C. As such, the reflector layer 701 may include reflector patches positioned within or between dielectric layers.

FIG. 7B illustrates an etch-stop layer 703 deposited above the reflector layer 701. Many of the layers are not labeled with a text description to avoid obscuring the drawings. Instead, the same reference numbers are used throughout the drawings with consistent shading and horizontally aligned layers. The etch-stop layer 703 may be, for example, silicon nitride.

FIG. 7C illustrates the deposition of a dielectric mid-layer 705 within which the metallic vias are to be formed. The dielectric mid-layer 705 may be, for example, tetraethyl orthosilicate (TEOS) or another dielectric material. The selection of the specific material utilized for the dielectric mid-layer 705 may depend on or be selected together with a compatible etching technique (e.g., a buffered oxide etchant (BOE)).

FIG. 7D illustrates the deposition of a dielectric cap layer 707. The dielectric cap layer is selected to be a material that is resistant to the etching approach used in the second single-damascene process that is used later to form the optical resonators. For example, the dielectric cap layer 707 may be NBLOK® or BLOK® materials available from Applied Sciences, Inc. The dielectric cap layer 707 may be a silicon carbide layer, alumina (Al₂O₃), a silicon nitride layer, a nitrogen-doped silicon carbide (NDC) layer, such as a layer, a silicon carbide deposited using plasma-enhanced chemical vapor deposition (PECVD) of trimethylsilane, and/or the like.

Notably, most of the dielectric cap layers described above are considered undesirable in many situations because they have relatively high dielectric constants (high-k materials) that increase capacitance. However, unlike in many applications, these materials are suitable for use in tunable optical metasurfaces in the specified location. The etch-stop layer 703, the dielectric mid-layer 705, and the dielectric cap layer 707 form the interconnect layer of the tunable optical metasurface. As described below, metallic vias are formed in the interconnect layer to electrically connect the optical resonators to driver components in underlying layers and/or external control lines. In some implementations, reflector patches provide intermediary electrical connections to the driver components, such that the metallic vias operate to connect the optical resonators to corresponding reflector patches, which are, in turn, connected (possibly via additional via layers) to various driver layers and/or control lines.

FIG. 7E illustrates a mask layer 709 added to allow for the etching of a via 710 through the interconnect layer. The via 710 is etched through the dielectric cap layer 707, the dielectric mid-layer 705, and the etch-stop layer 703.

FIG. 7F illustrates a first metallic barrier 711 deposited on the sidewalls and base of the via 710. The first metallic barrier 711 operates to, for example, prevent diffusion of the metal used to form the bulk of the metallic via into the surrounding dielectric materials and/or to prevent corrosion of the metallic vias. The first metallic barrier 711 may comprise, for example, one or more of tantalum (Ta), tantalum nitride (TaN), and titanium nitride (TiN).

FIG. 7G illustrates the bulk metal deposited within the via 710 to form the metallic via 713. The metallic vias may, for example, comprise copper or a copper alloy. Alternative metals or allows may include any suitable combination of silver, gold, titanium, tungsten, copper, or other conductive metal alloys.

FIG. 7H illustrates the chemical mechanical planarization (CMP) of the metallic via 713, the portion of the first metallic barrier 711 outside of the via 710, and a portion of the dielectric cap layer 707. Notably, a portion of the dielectric cap layer 707 (e.g., NBLoC® layer) remains. The first single-damascene process is completed to form the metallic vias within the interconnect layer of dielectric layers protected by the dielectric cap layer 707.

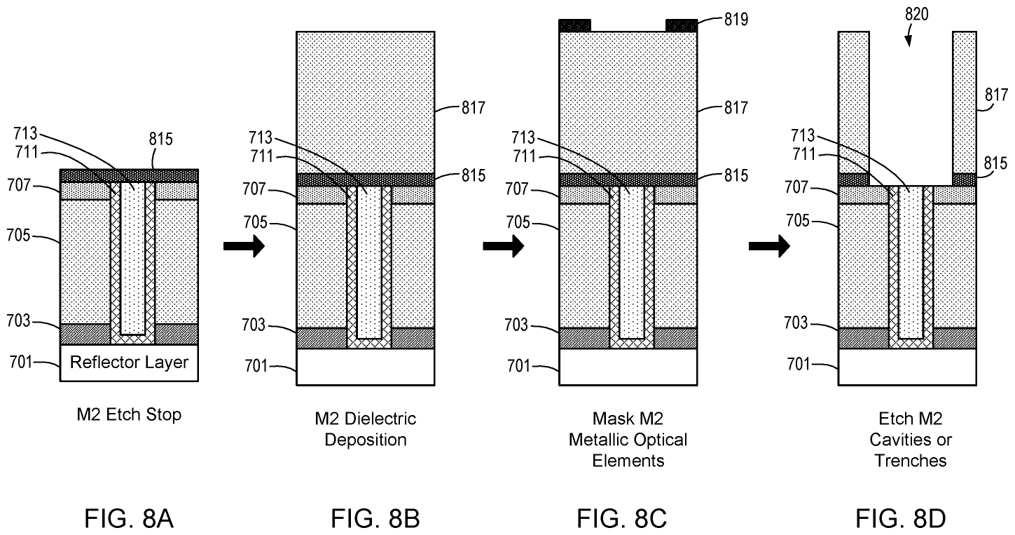

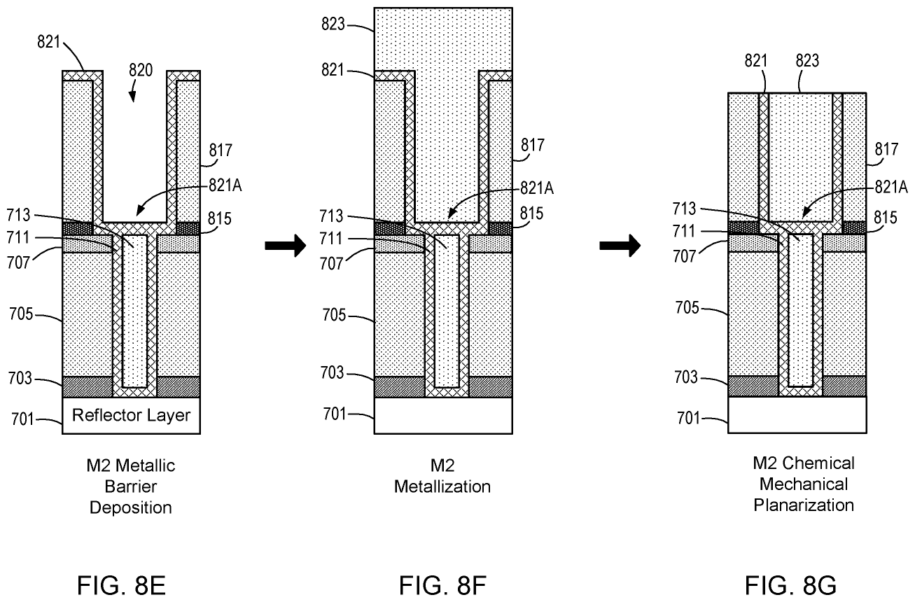

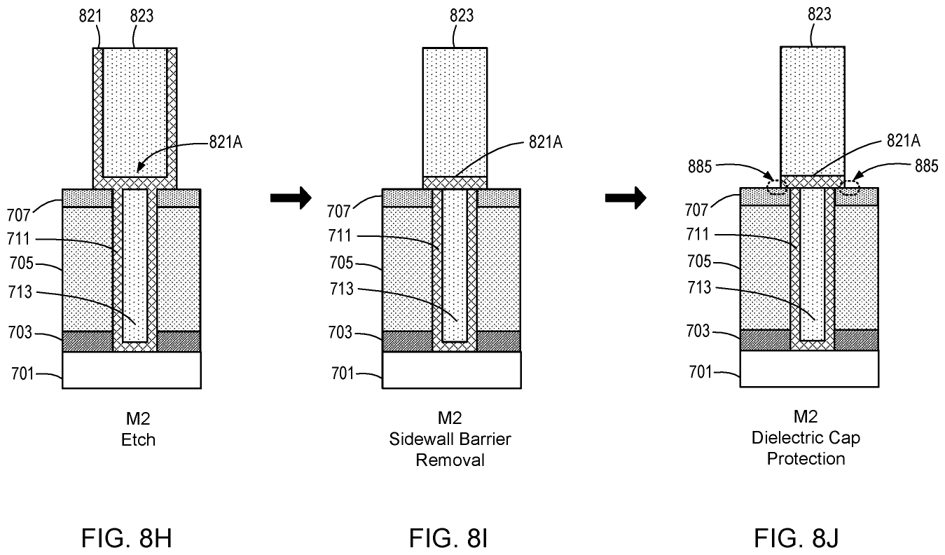

FIGS. 8A-8G illustrate block diagrams of a second single-damascene process to form optical resonators with metallic optical elements with a resonator etch-stop layer, according to one embodiment.

FIG. 8A illustrates a resonator etch-stop layer 815 applied to the top of the completed metallic via layer (referenced using reference numbers 701-713 that are described in conjunction with FIGS. 7A-H). The resonator etch-stop layer 815 may be, for example, a silicon nitride (SiN) material.

FIG. 8B illustrates the deposition of a resonator dielectric layer 817 to be etched to form a metallic optical element of an optical resonator in the resonator layer. The resonator dielectric layer 817 may be, for example, tetraethyl orthosilicate (TEOS) or another dielectric material suitable for etching. The selection of the specific material utilized for the resonator dielectric layer 817 may depend on or be selected together with a compatible etching technique (e.g., a buffered oxide etchant (BOE)).

FIG. 8C illustrates a resonator mask layer 819 added to control the etching of the resonator dielectric layer 817 down to the resonator etch-stop layer 815.

FIG. 8D illustrates a cavity or channel 820 etched into the resonator dielectric layer 817 that stops after the resonator etch-stop layer 815 to expose the surface of the metallic via 713. The resonator mask layer 819 is removed after the etching is completed. In some embodiments, the etching process may include two or more stages that utilize different etching techniques. For example, a BOE wet etch may be used to etch down to the resonator etch-stop layer 815, after which a more precise or controlled etching technique may be used to carefully remove the resonator etch-stop layer 815 without damaging the underlying metallic via 713, the first metallic barrier 711, and/or the dielectric cap layer 707.

The dielectric cap layer 707 prevents the resonator etch step of the second single-damascene process from destroying the dielectric material within the interconnect layer or undercutting the sidewalls of the cavity or channel 820. Moreover, the dielectric cap layer 707 operates to ensure that the shape of the already-formed metallic via 713 and the shape of the soon-to-be-formed metallic optical element are well-defined.

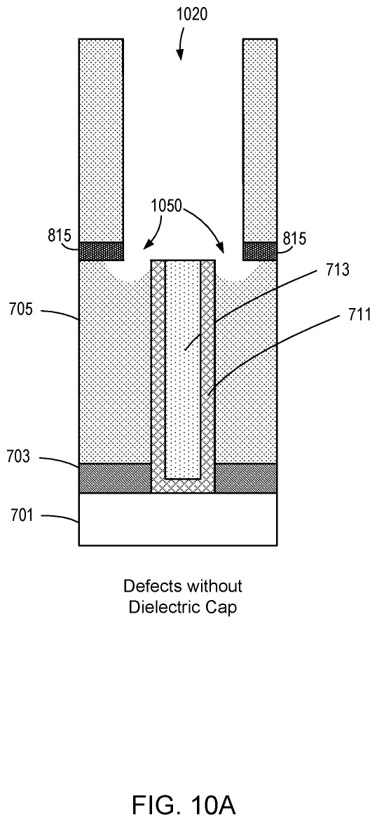

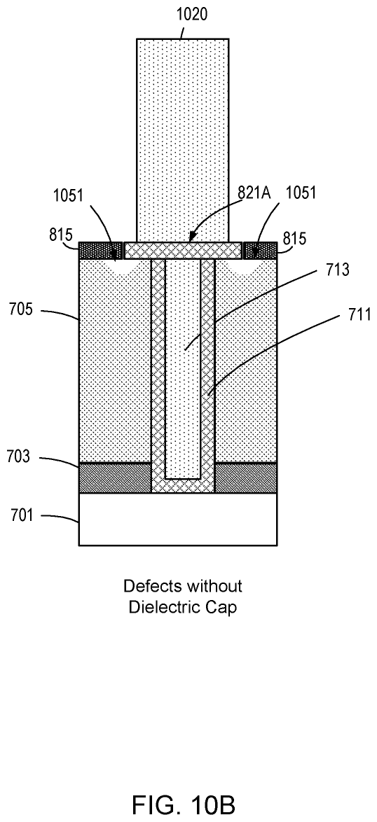

FIG. 10A illustrates a block diagram of exemplary etching defects (e.g., voids 1050) that are created during the etching process of the second single-damascene process in the absence of a protective dielectric cap layer, according to one embodiment. Since the metallic via 713 (together with the first metallic barrier 711) is narrower than the cavity or trench 1020, the etchant used to form the cavity or trench 1020 will etch away at the dielectric mid-layer 705. The resulting deposition of copper or other metal into the voids 1050 will result in weak connections and undesirable performance and/or possibly provide an undesirable electrical connection to an adjacent metallic optical element.

Returning to FIG. 8D, the dielectric cap layer 707 maintains the target shape of the cavity or channel 820 and prevents undesired etching of the already-completed interconnect layer during the second single-damascene process used to form the resonator layer.

FIG. 8E illustrates a second metallic barrier 821 deposited on the sidewalls and base of the cavity or trench 820. The second metallic barrier 821 operates to, for example, prevent diffusion of the metal used to form the bulk of the metallic optical elements into the surrounding dielectric materials and/or to prevent corrosion of the optical elements. The second metallic barrier 821 may comprise, for example, one or more of tantalum (Ta), tantalum nitride (TaN), and titanium nitride (TIN).

Portions of the second metallic barrier 821 may eventually be removed, such as the portions on the sidewalls as described below. However, the base 821A of the second metallic barrier 821 may remain in place to prevent diffusion of the metal (e.g., copper) from the metallic optical element 823 into the dielectric cap layer 707 (and possibly the resonator etch-stop layer 815 if it is not removed). As such, the sequential single-damascene process, including the first single-damascene process to form the metallic vias in the interconnect layer and the second single-damascene process to form the metallic optical elements 823 in the resonator layer, results in a physical separation of the metallic via and the metallic optical element 823 by the base 821A of the second metallic barrier 821.

FIG. 8F illustrates the bulk metal deposited within the cavity or channel 820 to form the metallic optical element 823. The process may include, for example, a metal seed deposition followed by electroplating.

FIG. 8G illustrates the use of chemical mechanical planarization (CMP) to finalize the formation of the metallic optical element 823 and remove the second metallic barrier 821 that is outside of the cavity or channel 820.

FIG. 8H illustrates the removal of the resonator dielectric layer 817 and resonator etch-stop layer 815, according to one embodiment. As illustrated, the second metallic barrier 821 on the sidewalls of the metallic optical element 823 are now exposed. In some examples, a wet etch may be used to remove the resonator dielectric layer 817 that may or may not be capable of removing the resonator etch-stop layer 815. In embodiments in which the wet etch cannot remove the resonator etch-stop layer 815, the resonator etch-stop layer 815 may be removed by a plasma etch or another suitable etching approach.

FIG. 8I illustrates the second metallic barrier 821 removed from the sidewalls of the metallic optical element 823 to expose the sidewalls of the metallic optical element 823 (e.g., exposed copper). A dielectric passivation layer (e.g., optically reflective and/or optically transparent), such as silicon nitride, may be applied to the sidewalls and/or top of the metallic optical element 823. An optical resonator is formed by the metallic optical element 823, an adjacent metallic optical element (not illustrated), and the gap therebetween. As described herein, the gap is filled with a tunable dielectric material to create a tunable optical resonator.

FIG. 8J highlights corner regions 885 of the device where the dielectric cap layer 707 interfaces with the remaining base 821A of the second metallic barrier. The dielectric cap layer operates to protect and prevent etching of the dielectric mid-layer 705 during the etching and material removal processes described in conjunction with FIGS. 8H and 8I.

FIG. 10B illustrates a block diagram of exemplary etching defects (e.g., voids 1050) created in the absence of a protective dielectric cap layer 707, according to one embodiment. As illustrated, without the dielectric cap layer 707, an etching solution (e.g., buffered oxide etch or BOE) may travel along the interface of the base 821A of the second metallic barrier and the resonator etch-stop layer 815. The etching solution may etch voids in the dielectric mid-layer 705 and undermine the integrity of the other layers (e.g., resulting in weak connections, errors in subsequent passivation coatings, erroneous liquid crystal depositions, etc.).

As described herein, the dielectric cap layer 707 allows for the formation of a high-aspect-ratio (e.g., narrow and tall) metallic via 713 directly beneath a relatively wide metallic optical element 823. A dual-damascene process does not allow for the formation of high-aspect-ratio metallic via 713 directly beneath the relatively wide metallic optical element 823. Moreover, traditional single-damascene processes that do not incorporate a protective dielectric cap layer dielectric cap layer 707 are unsuitable for the relative feature sizes.

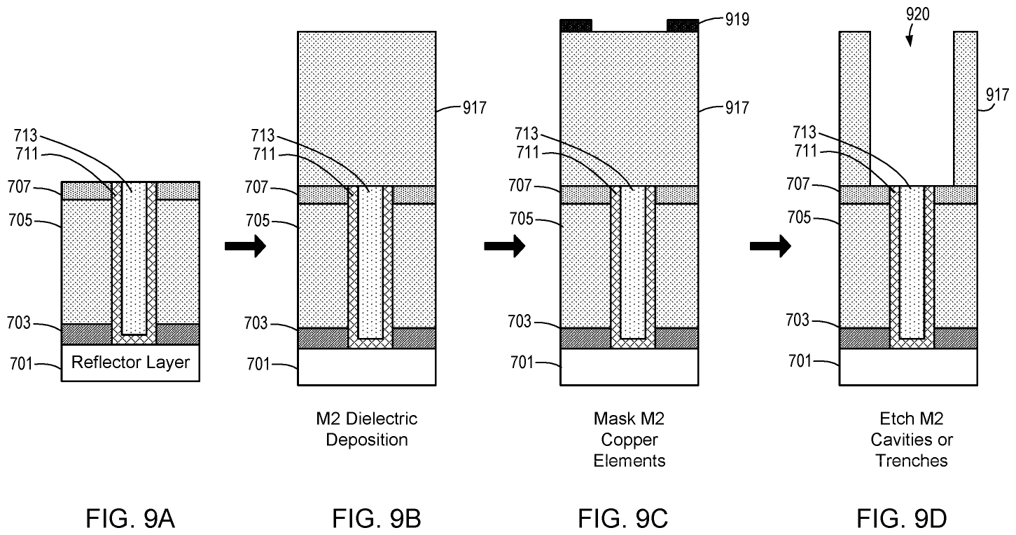

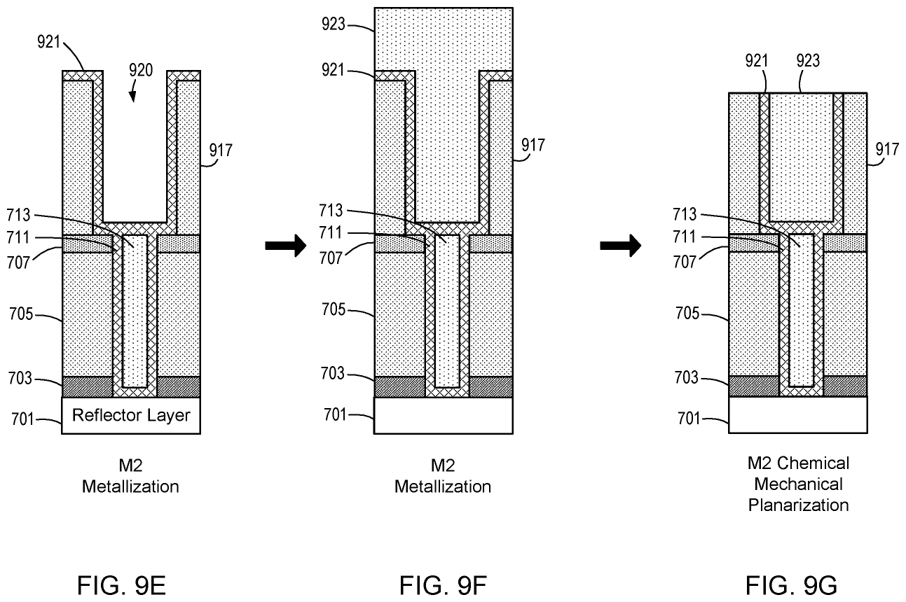

FIGS. 9A-9G illustrate block diagrams of an alternative second single-damascene process to form a metal structure without a resonator etch-stop layer, according to one embodiment.

FIG. 9A illustrates a completed metallic via layer (referenced using reference numbers 701-713 that are described in conjunction with FIGS. 7A-H).

FIG. 9B illustrates the deposition of a resonator dielectric layer 917 to be etched to form a metallic optical element of an optical resonator in the resonator layer. The resonator dielectric layer 917 may be, for example, tetraethyl orthosilicate (TEOS) or another dielectric material suitable for etching. The selection of the specific material utilized for the resonator dielectric layer 917 may depend on or be selected together with a compatible etching technique (e.g., a buffered oxide etchant (BOE)).

FIG. 9C illustrates a resonator mask layer 919 added to control etching of the resonator dielectric layer 917.

FIG. 9D illustrates a cavity or channel 920 etched into the resonator dielectric layer 917 to expose the surface of the metallic via 713. Due to the lack of an etch-stop layer (e.g., 815 in FIGS. 8A-8G), an etching process that will not damage the metallic via 713 may be selected. The resonator mask layer 919 is removed after the etching is completed. In some embodiments, the etching process may include two or more stages that utilize different etching techniques. For example, a BOE wet etch may be used to etch down close to the metallic via 713, after which a more precise or controlled etching technique may be used to carefully remove the remaining resonator dielectric layer 917 without damaging the underlying metallic via 713, the first metallic barrier 711, and/or the dielectric cap layer 707.

The dielectric cap layer 707 prevents the resonator etch step of the second single-damascene process from destroying the dielectric material within the interconnect layer or undercutting the sidewalls of the cavity or channel 920. Moreover, the dielectric cap layer 707 operates to ensure that the shape of the already-formed metallic via 713 and the shape of the soon-to-be-formed metallic optical element are well-defined.

FIG. 9E illustrates a second metallic barrier 921 deposited on the sidewalls and base of the cavity or channel 920.

FIG. 9F illustrates the bulk metal deposited within the cavity or channel 920 to form the metallic optical element 923. The process may include, for example, a metal seed deposition followed by electroplating.

FIG. 9G illustrates the use of chemical mechanical planarization (CMP) to finalize the formation of the metallic optical element 923 and remove the second metallic barrier 921 that is outside of the cavity or channel 920. As previously described but not illustrated, the rest of the resonator dielectric layer 917 is removed to expose the sidewalls of the metallic optical element 923 coated with the second metallic barrier 921. The second metallic barrier 921 is then removed from the sidewalls of the metallic optical element 923 to expose the sidewalls of the metallic optical element 923. A dielectric passivation layer (e.g., optically reflective and/or optically transparent), such as silicon nitride, may be applied to the sidewalls and/or top of the metallic optical element 923. An optical resonator is formed by the metallic optical element 923, an adjacent metallic optical element (not illustrated), and the gap therebetween. As described herein, the gap is filled with a tunable dielectric material to create a tunable optical resonator. Again, the dielectric cap layer 707 allows for the formation of a high-aspect-ratio (e.g., narrow and tall) metallic via 713 directly beneath a relatively wide metallic optical element 923.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element. This disclosure should, therefore, be understood to encompass at least the following claims and all possible permutations thereof.

What is claimed:

1. An optical metasurface, comprising:
an optical reflector layer that includes a plurality of metallic reflector patches;
a resonator layer with an array of optical resonators, wherein each optical resonator is formed by two vertically extending metallic optical elements positioned adjacent to one another to form a gap therebetween;
an interconnect layer positioned between the optical reflector layer and the resonator layer, wherein the interconnect layer comprises a plurality of metallic vias, wherein each metallic via electrically connects to one of the metallic optical elements of the resonator layer;
a first conductive barrier deposited during a first single-damascene process used to form the metallic vias of the interconnect layer; and
a second conductive barrier deposited during a second single-damascene process used to form the metallic optical elements of the resonator layer, wherein the second conductive barrier physically separates the metallic vias and the metallic optical elements.

2. The metasurface of claim 1, wherein each metallic via is formed as a copper via, and wherein each metallic optical element comprises a copper optical element.

3. The metasurface of claim 1, wherein each metallic reflector patch is formed as a copper reflector patch.

4. The metasurface of claim 1, wherein the first conductive barrier layer comprises one or more of tantalum (Ta), tantalum nitride (TaN), and titanium nitride (TIN), and wherein the second conductive barrier layer comprises one or more of tantalum (Ta), tantalum nitride (TaN), and titanium nitride (TiN).

5. The metasurface of claim 1, wherein each metallic via connects multiple metallic optical elements to a single metallic optical reflector patch, via the first and second conductive barriers.

6. The metasurface of claim 1, wherein the optical reflector layer comprises a two-dimensional array of reflector patches.

7. The metasurface of claim 1, wherein the array of optical resonators of the resonator layer comprises a two-dimensional array of optical resonators.

8. The metasurface of claim 7, wherein the two vertically extending metallic optical elements of each optical resonator in the two-dimensional array of optical resonators comprises a rectangular prism pillar.

9. The metasurface of claim 1, wherein the array of optical resonators of the resonator layer comprises a one-dimensional array of optical resonators.

10. The metasurface of claim 9, wherein the two vertically extending metallic optical elements of each optical resonator in the one-dimensional array of optical resonators comprises an elongated rectangular rail.

11. The metasurface of claim 1, wherein the resonator layer further comprises a tunable dielectric material that has a tunable refractive index positioned within the gap between the adjacent metallic optical elements of each respective optical resonator, and wherein the tunable dielectric material comprises one or more of: liquid crystal, an electro-optic polymer, electro-optical crystal, and chalcogenide glass.

12. An optical metasurface, comprising:
an optical reflector layer that includes a plurality of metallic reflector patches;
a resonator layer with an array of optical resonators, wherein each optical resonator is formed by two vertically extending metallic optical elements positioned adjacent to one another to form a gap therebetween;
an interconnect layer positioned between the optical reflector layer and the resonator layer, the interconnect layer including:
a dielectric etch-stop layer to control an etch depth in the interconnect layer,
a dielectric mid-layer to be etched as part of a first single-damascene process, and
a dielectric cap layer resistant to being etched by an etching solution used to etch the resonator layer as part of a second single-damascene process; and
a plurality of metallic vias formed within the interconnect layer as part of the first single-damascene process, wherein each metallic via electrically connects to one of the metallic optical elements of the resonator layer.

13. The metasurface of claim 12, wherein each metallic via electrically connects one of the metallic optical elements of the resonator layer to one of the metallic reflector patches of the optical reflector layer.

14. The metasurface of claim 12, wherein the dielectric etch-stop layer of the interconnect layer comprises at least one of a silicon nitride layer, a silicon carbide layer, and a silicon carbonitride layer.

15. The metasurface of claim 12, wherein the dielectric mid-layer of the interconnect layer comprises tetraethyl orthosilicate (TEOS).

16. The metasurface of claim 12, wherein the dielectric cap layer comprises at least one of a silicon carbide layer, alumina (Al₂O₃), and a silicon nitride layer.

17. The metasurface of claim 12, wherein the dielectric cap layer comprises a nitrogen-doped silicon carbide (NDC) layer.

18. The metasurface of claim 12, wherein the dielectric cap layer comprises a BLOK material layer of silicon carbide deposited using plasma-enhanced chemical vapor deposition (PECVD) of trimethylsilane.

19. The metasurface of claim 12, wherein the resonator layer further comprises a tunable dielectric material that has a tunable refractive index positioned within the gap between the adjacent metallic optical elements of each respective optical resonator, and wherein the tunable dielectric material comprises one or more of: liquid crystal, an electro-optic polymer, electro-optical crystal, and chalcogenide glass.

20. The metasurface of claim 12, wherein each metallic via is formed as a copper via, wherein each metallic optical element comprises a copper optical element, and wherein each metallic reflector patch is formed as a copper reflector patch.

21. The metasurface of claim 12, wherein the array of optical resonators of the resonator layer comprises a two-dimensional array of optical resonators.

22. The metasurface of claim 12, wherein the array of optical resonators of the resonator layer comprises a one-dimensional array of optical resonators.

23. The metasurface of claim 12, further comprising:
a first conductive barrier deposited during the first single-damascene process used to form the metallic vias of the interconnect layer, wherein the first conductive barrier physically separates the metallic vias from the metallic reflector patches; and
a second conductive barrier deposited during the second single-damascene process used to form the metallic optical elements of the resonator layer, wherein the second conductive barrier physically separates the metallic vias and the metallic optical elements.

24. A method to manufacture an optical metasurface, comprising:
forming an optical reflector layer that includes a plurality of metallic reflector patches;
forming, by a first single-damascene process, an interconnect layer above the optical reflector layer that includes a plurality of metallic vias, the interconnect layer including an interconnect dielectric etch-stop layer, an interconnect dielectric mid-layer, and an etch-resistant dielectric cap layer; and
forming, by a second single-damascene process, a resonator layer with an array of optical resonators, wherein each optical resonator is formed as two vertically extending metallic optical elements positioned adjacent to one another to form a gap therebetween,
wherein each metallic via electrically connects to one of the metallic optical elements of the resonator layer.

25. The metasurface of claim 24, further comprising:
positioning a tunable dielectric material that has a tunable refractive index positioned within the gap between the adjacent metallic optical elements of each respective optical resonator, and wherein the tunable dielectric material comprises one or more of: liquid crystal, an electro-optic polymer, electro-optical crystal, and chalcogenide glass.

26. The method of claim 24, wherein the metallic optical elements formed via the second single-damascene process comprise a plurality of copper pillars vertically extending from a dielectric layer.

27. The method of claim 26, wherein the plurality of copper pillars comprises a two-dimensional array of copper pillars.

28. The method of claim 26, wherein the plurality of copper pillars comprises a one-dimensional array of elongated copper rails.

29. The method of claim 24, wherein the first single-damascene process includes a deposition of a first conductive barrier material, and wherein the second single-damascene process includes the deposition of a second conductive barrier material, such that the metallic vias are physically separated from the metallic optical elements by the second conductive barrier material.
